(19) United States
(12) Patent Application Publication
(10) Pub. No.: US 2015/0194686 A1
(43) Pub. Date: Jul. 9, 2015

(54) CATALYTIC HYDROGEN COMBUSTOR

(71) Applicants: Jacques Florian Nicole, Palo Alto, CA (US); Damodara Poojary, Campbell, CA (US); Bret Robert Armanini, Dublin, CA (US)

(72) Inventors: Jacques Florian Nicole, Palo Alto, CA (US); Damodara Poojary, Campbell, CA (US); Bret Robert Armanini, Dublin, CA (US)

(73) Assignee: International Engine Intellectual Property Company LLC, Lisle, IL (US)

(21) Appl. No.: 14/410,818

(22) PCT Filed: Jun. 28, 2012
(86) PCT No.: PCT/US12/44507

§ 371 Date: Dec. 23, 2014

(51) Int. Cl. H01M 8/04

(52) U.S. Cl. CPC H01M 8/04805

(57) ABSTRACT

A catalytic hydrogen combustor is disclosed that is adapted to combust substantially all the hydrogen in the fuel cell exhaust gas during both steady state operation and for short duration higher hydrogen concentration pulses. Hydrogen combustion is catalyzed in two zones, a first zone in which a lower level of catalyst activity is used to catalyze combustion of a higher concentration hydrogen pulse as it moves through the zone and a second zone in which a higher level of catalyst activity is used to catalyze combustion of a lower concentration of hydrogen that is characteristic of steady state fuel cell operation.

### BACKGROUND

Embodiments described herein concern catalytic combustion of hydrogen. One embodiment concerns catalytic combustion of hydrogen in the fuel cell exhaust of a fuel cell powered vehicle.

Polymer Electrolyte Membrane (PEM) fuel cells emit exhaust gas during operation that is primarily air, water and hydrogen. The concentration of hydrogen in the exhaust from a PEM fuel cell during steady state operation is relatively low. A simple calculation using the commonly accepted hydrogen utilization, see for instance U.S. Pat. No. 6,569,549, and air utilization gives a concentration of hydrogen in the combined anode and cathode exhaust stream of about 1%. For short periods during a change in operation of the PEM fuel cell, the amount of hydrogen emitted can be significantly larger than is emitted during steady state operation. Hydrogen in fuel cell exhaust can create a risk of uncontrolled rapid hydrogen combustion.

### SUMMARY

Embodiments described herein relate to systems and methods for reducing hydrogen concentration in a stream of gas that may be exhaust from a fuel cell. One embodiment provides a catalytic hydrogen combustor comprising a monolith that forms a plurality of passageways that extend along a flow direction from an inlet to an outlet. A first coating containing hydrogen combustion catalyst is disposed on walls of the monolith passages in a first zone of the monolith that extends from the inlet to a transition location between the inlet and the outlet. A second coating containing hydrogen combustion catalyst is disposed on walls of the monolith passages in a second zone of the monolith that extends from the transition location to the outlet. The second coating is formulated to catalyze hydrogen combustion at a greater rate than the first coating.

Another embodiment provides a method of reducing an amount of hydrogen in fuel cell exhaust for steady state operation exhaust flow that contains a low concentration of hydrogen and for exhaust flow containing a short duration pulse of higher concentration hydrogen. The method includes directing the flow of exhaust through a first catalytic combustion zone in which the exhaust is exposed to a first hydrogen combustion catalyst. Subsequently, the flow of exhaust is directed through a second catalytic combustion zone in which the exhaust is exposed to a second hydrogen combustion catalyst. The second catalytic combustion zone is configured and the second hydrogen combustion catalyst is formulated to catalyze combustion of substantially all hydrogen in a flow of fuel cell vehicle exhaust during steady state operation. The first catalytic combustion zone is configured and the first hydrogen combustion catalyst is formulated to catalyze combustion that at least substantially reduces the concentration of hydrogen in exhaust containing a pulse of higher concentration hydrogen.

### BRIEF DESCRIPTION OF THE DRAWINGS

FIG. 1 is an oblique view of a catalytic hydrogen combustor.

FIG. 2 is a partially cut away side view of the catalytic hydrogen combustor of FIG. 1.

FIG. 3 illustrates the compositions of fuel cell exhaust during an operation transition and during steady state operation.

FIG. 4 illustrates a catalytic hydrogen combustor having two zones of ceramic and catalyst coating.

FIG. 5 illustrates the operating temperatures along the length of a catalytic hydrogen combustor during a steady state operating condition.

FIG. 6 illustrates the operating temperatures along the length of a catalytic hydrogen combustor during a second steady state operating condition.

FIG. 7 illustrates the surface temperatures at locations along the length of a catalytic hydrogen combustor during a time period that includes a hydrogen pulse and thereafter.

### DETAILED DESCRIPTION

Embodiments described herein concern catalytic combustion of hydrogen and an apparatus that accomplishes that combustion. More particularly, the embodiments concern catalytic combustion of hydrogen in a gas stream in which the concentration of hydrogen is not constant.

PEM fuel cells emit exhaust gas that contains at least hydrogen, oxygen, water and nitrogen. A catalytic hydrogen combustor in a fuel cell exhaust should initiate combustion of hydrogen in fuel cell exhaust gas at a low temperature (ignition temperature) and should operate at a low temperature during the fuel cell operation. Catalyzed hydrogen combustion releases heat that raises the temperature of the exhaust gas, catalyst and surrounding structures. Overheating of a catalytic combustor can result in two undesirable consequences. High temperatures can sinter the catalytic component on the supporting monolith diminishing the effectiveness of the catalytic component to catalyze hydrogen combustion. Also, should temperatures reach the auto-ignition temperature of hydrogen, rapid and uncontrolled combustion of hydrogen could result.

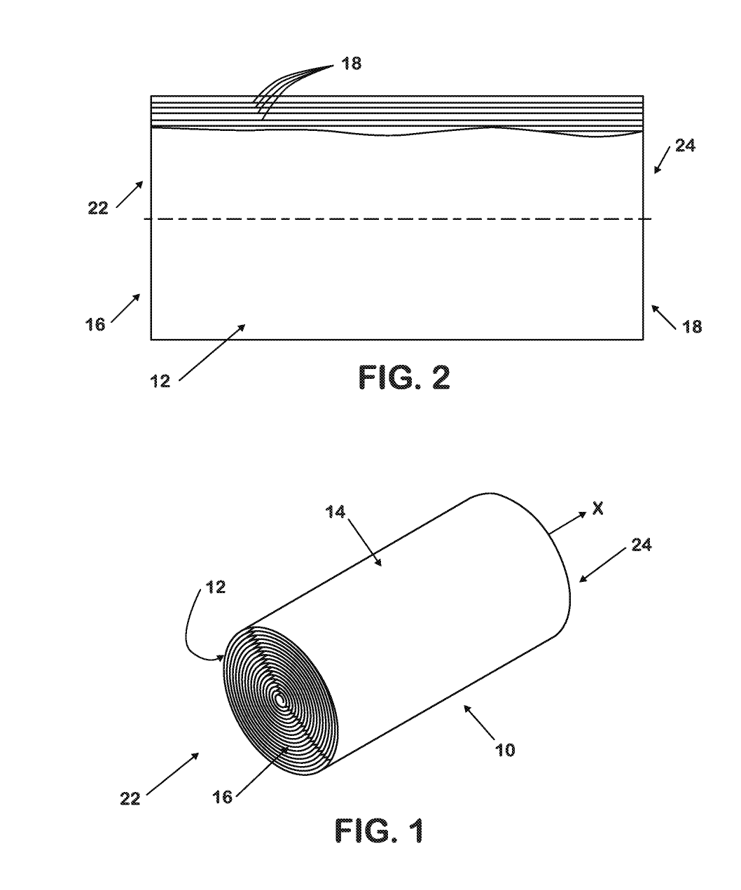

FIG. 1 illustrates a catalytic hydrogen combustor 10. A monolith 12 forms passages 18 such that gas flows through the monolith 12 from an inlet end 22 of the catalytic hydrogen combustor to an outlet end 24 of the catalytic hydrogen combustor 10. The monolith 12 comprises a generally cylindrical outer shell 14 that forms a cylinder that lies along an axis X along a direction from the inlet end 22 of the catalytic hydrogen combustor 10 to the outlet end 24. The monolith 12 further comprises a honeycomb element 16 that is positioned within the outer shell 14 and that extends along the axis X.

The honeycomb element 16 of the monolith 12 allows gas to flow through the honeycomb element 16 from the inlet end 22 to the outlet end 24 and presents surfaces that form passages through which gas flows. The honeycomb element 16 may form a series of connected chambers that extend from the inlet end 22 to the outlet end 24 and the chambers should be sized and configured such that at least substantially all of the gas passing through the honeycomb element 16 will pass over surfaces of the honeycomb element 16 sufficiently to allow a catalyst on the surface to catalyze combustion of hydrogen in the gas passing through the honeycomb element 16. The configuration of the honeycomb element 16 is not limited to any configuration or configurations. The honeycomb element 16 shown by FIG. 1 forms channels 18 that provide a path for gas to pass through the honeycomb element 16 in the direction of the axis X from the inlet end 22 to the outlet end 24.

The monolith 12 conducts heat and has sufficient mass and specific heat so that heat released by hydrogen combustion does not raise the temperature of the monolith 12 to an unacceptable level. The honeycomb 16 of the monolith 12 is formed of corrugated stainless steel foil that is approximately .04 mm thick. The monolith 12 may be of the LS type supplied by Emitec USA.

The honeycomb element 16 is coated by a ceramic and hydrogen combustion catalyst coating on the surfaces that define the channels 18. The hydrogen combustion catalyst is platinum and the supporting ceramic is gamma alumina. As discussed below, the amount of heat created by catalyzed hydrogen combustion in a region of the monolith depends on the concentration of hydrogen in the fuel cell exhaust and the concentration of hydrogen combustion catalyst particles on the surface of the monolith. The structure of a monolith with a platinum and gamma aluminum coating is known to those of skill in the art and is described by U.S. Pat. No. 7,610,752, which is owned by the assignee of this application, and is incorporated by reference herein.

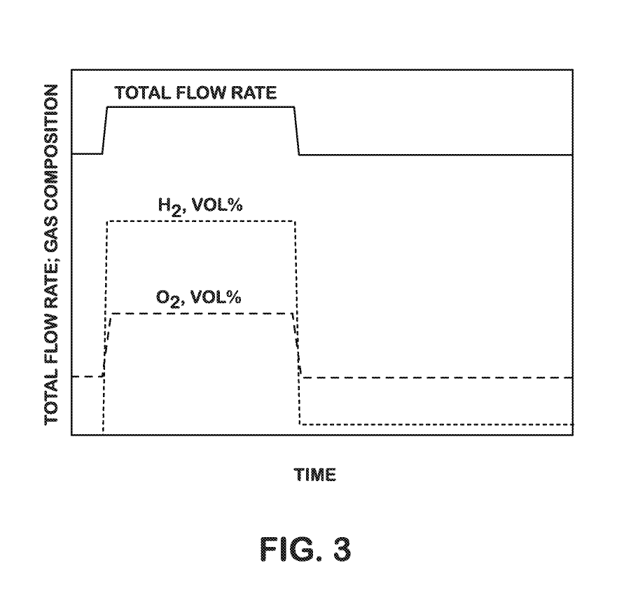

Fuel cells that power vehicles operate for extended periods, minutes to hours at a steady state condition emitting exhaust gas of substantially constant composition. This steady state operation creates exhaust gas typically having a hydrogen concentration of less than one percent hydrogen in the combined anode and cathode fuel cell exhausts. During transitions in fuel cell load and operation, the fuel cell can emit a pulse of hydrogen into the exhaust gas that can result in the exhaust gas comprising ten to twenty percent hydrogen during for a period that lasts several seconds. FIG. 3 illustrates the composition of fuel cell exhaust for a hydrogen pulse emission at the left of the graph followed by steady state composition at the right of the graph. Fuel cell exhaust gas contains water that affects reaction kinetics. The exhaust conditions near stoichiometry during the pulse but are not near stoichiometry during steady state operation. A catalytic hydrogen combustor catalyzes combustion of substantially all hydrogen in the exhaust gas that enters the monolith 12 for both steady state and pulse exhaust gas compositions and maintains the monolith 12 at an acceptably low temperature.

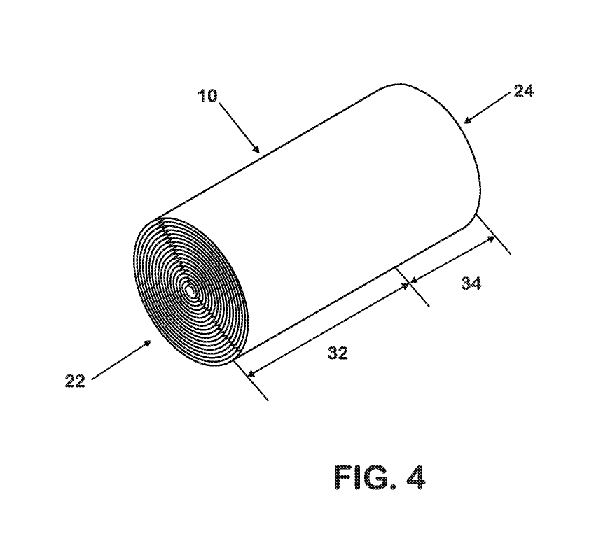

FIG. 4 illustrates the combustor 10 having a coating that includes a hydrogen combustion catalyst in two zones, a first zone 32 extending from the inlet end 22 to a transition location intermediate the inlet 22 and the outlet 24 and a second zone 34 extending from the outlet end 24 to the transition location to meet the first zone 32. The first zone 32 extends greater than half the length of the combustor 10. Within the first zone 32, the monolith 12 is coated with a platinum and gamma alumina coating in which a low concentration of platinum is present. An example of such a coating for the first zone 32 is a platinum and gamma alumina coating in which the platinum is 0.33 weight percent of the gamma alumina and platinum coating. The second zone 34 extends from the first zone 32 the remainder of the length of the combustor 10 to the outlet end 24. Within the second zone 34, the monolith 12 is coated with a platinum and gamma alumina coating in which a higher concentration of platinum is present than is present in the first zone 32. An example of such a coating for the second zone 34 is a platinum and gamma alumina coating in which the platinum catalyst is 2 weight percent of the gamma alumina and platinum coating. The platinum catalyst creates heat during catalytic combustion of hydrogen. The greater the density of catalyst, the greater the amount of heat that is created per unit area of coated surface.

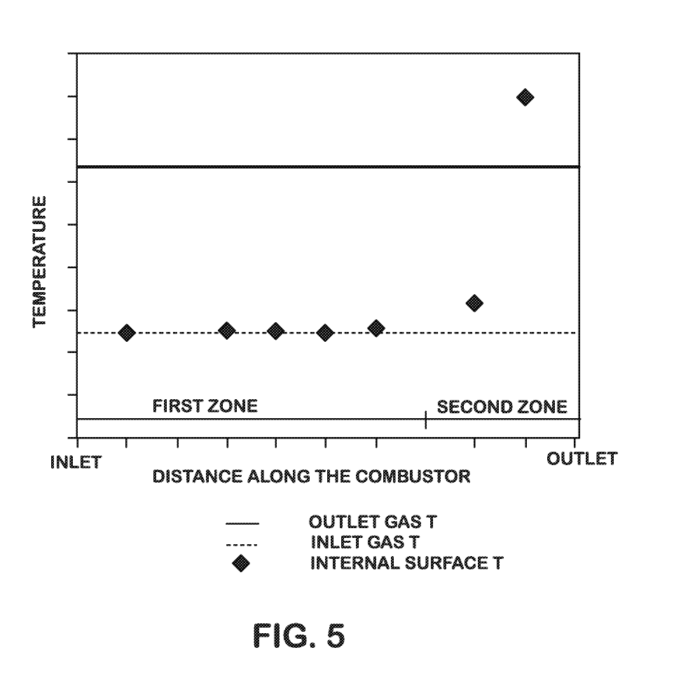

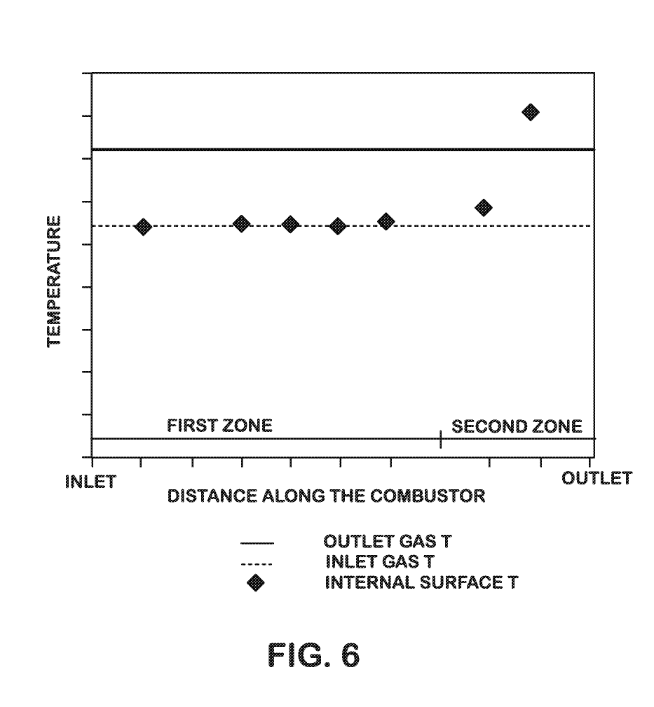

FIGS. 5 and 6 show the temperature within the combustor 10 along its length for two different steady state fuel cell exhaust gases. FIG. 5 shows the temperatures of the combustor 10 for fuel cell exhaust at a relatively low inlet temperature and comprised of 0.75 percent hydrogen. FIG. 6 shows the temperatures of the combustor 10 for fuel cell exhaust at a higher inlet temperature than is shown by FIG. 5 and comprised of 0.5 percent hydrogen. As can be seen by the temperatures shown by FIGS. 5 and 6, little heat is created by catalytic combustion in the first zone 32 during steady state fuel cell operation that emits low hydrogen concentration exhaust gas. The measured temperatures in the first zone 32 do not differ significantly from the inlet gas temperature indicating that the measured temperature is approximately that of the exhaust gas with little if any heating due to catalytic combustion. However, the markedly increased temperatures in the second zone 34 shows significant catalytic combustion of that steady state exhaust in the second zone 34.

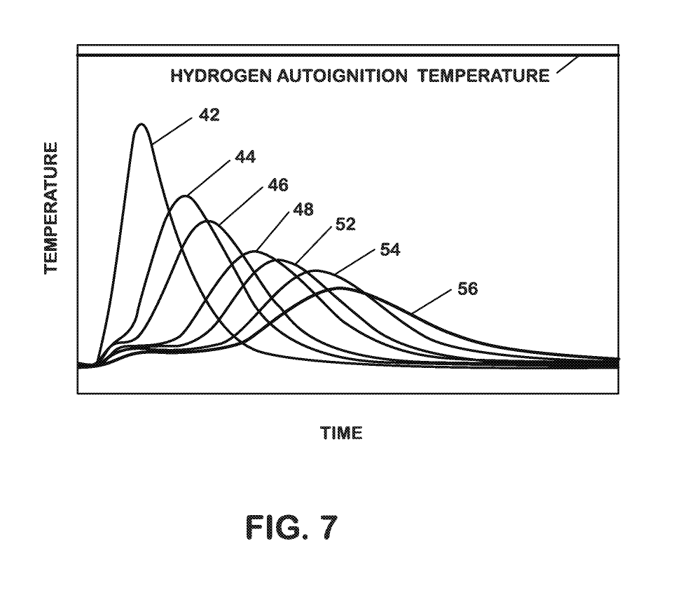

FIG. 7 shows temperature at locations along the combustor 10 from the inlet end 22 to the outlet end 24 for a period of time during which inlet exhaust gas included a hydrogen pulse that exceeded ten percent of the inlet exhaust gas. The curve 42 is at a location that is within the combustor 10 that is a distance from the inlet 22 that is one tenth the combustor length from the inlet end 22 to the outlet end 24. The curve 44 is at a location that is within the combustor 10 that is a distance from the inlet 22 that is three tenths the combustor length. The curve 46 is at a location that is within the combustor 10 that is a distance from the inlet 22 that is four tenths the combustor length. The curve 48 is at a location that is within the combustor 10 that is a distance from the inlet 22 that is six tenths the combustor length. The curve 52 is at a location that is within the combustor 10 that is a distance from the inlet 22 that is eight tenths the combustor length. The curve 54 is at a location that is within the combustor 10 that is a distance from the inlet 22 that is nine tenths the combustor length. The locations of the temperatures shown by curves 42, 44, 46, and 48 are within the first zone 32 of the combustor 10. The locations of the temperatures shown by curves 52 and 54 are within the second zone 34 of the combustor 10.

As shown by FIG. 7, the catalyst coating in the first zone 32 is effective in catalyzing combustion of hydrogen in an exhaust gas having hydrogen concentration of the hydrogen pulse where the catalyst coating in the first zone 32 did not catalyze significant combustion of hydrogen for fuel cell exhaust gas having a hydrogen concentration based on steady state operation as shown by FIGS. 5 and 6. As is also shown by FIG. 7, the maximum temperature occurs progressively later at locations that are increasing distances from the inlet 22 as the heat wave travels through the combustor 10. The maximum temperature in the combustor 10 decreases with distance from the inlet 22 indicating that the amount of hydrogen that is combusted decreases with distance from the inlet 22. The temperature curves in FIG. 7 increase to a maximum value and decrease prior to locations that are farther from the inlet 22 reaching the maximum temperature. The duration of the hydrogen pulse is less than the time for the heat wave to travel from the inlet end 22 to the outlet end 24 of the hydrogen combustor 10. The decrease of maximum temperature extends into the second zone 34 despite the higher platinum catalyst density in the second zone 34. Unlike the hydrogen combustion for the low hydrogen concentration steady state fuel cell exhaust, significant combustion of the hydrogen pulse occurs in the first zone 32 that significantly diminishes the amount of hydrogen in the exhaust gas that reaches the second zone 34 of the combustor 10.

An embodiment of a catalytic hydrogen combustor may comprise a monolith that forms a plurality of passageways that extend along a flow direction from an inlet to an outlet, a first coating containing hydrogen combustion catalyst may be disposed on surfaces of the monolith that are adjacent to passageways in a first zone of the monolith between the inlet and a transition location between the inlet and the outlet, a second coating containing hydrogen combustion catalyst may be disposed on surfaces of the monolith that are adjacent to passageways in a second zone of the monolith between the transition location and the outlet and the second coating formulated to catalyze hydrogen combustion at a greater rate than the first coating.

The first coating of the embodiment of a catalytic hydrogen combustor may comprise ceramic and a hydrogen combustion catalyst and the second coating may comprise ceramic and a hydrogen combustion catalyst. The ceramic of the first coating may be gamma alumina and the hydrogen combustion catalyst of the first coating may be platinum. The ceramic of the second coating may be gamma alumina and the hydrogen combustion catalyst of the second coating may be platinum. The weight percent of platinum in the second coating may be greater than the weight percent of platinum in the first coating. The weight percent of platinum in the second coating may be approximately 2 and the weight percent of platinum in the first coating may be approximately 0.33.

An embodiment of a catalytic hydrogen combustor may comprise a monolith that forms a plurality of passageways that extend along a flow direction from an inlet to an outlet and the monolith may comprise a honeycomb element and an outer shell that surrounds the honeycomb element from the inlet to the outlet. A first coating containing hydrogen combustion catalyst may be disposed on surfaces of the monolith that are adjacent to passageways in a first zone of the monolith between the inlet and a transition location between the inlet and the outlet, a second coating containing hydrogen combustion catalyst may be disposed on surfaces of the monolith that are adjacent to passageways in a second zone of the monolith between the transition location and the outlet and the second coating may be formulated to catalyze hydrogen combustion at a greater rate than the first coating. The first coating of the embodiment of a catalytic hydrogen combustor may comprise ceramic and a hydrogen combustion catalyst and the second coating may comprise ceramic and a hydrogen combustion catalyst. The ceramic of the first coating may be gamma alumina and the hydrogen combustion catalyst of the first coating may be platinum and the wherein the ceramic of the second coating may be gamma alumina and the hydrogen combustion catalyst of the second coating may be platinum. The weight percent of platinum in the second coating may be greater than the weight percent of platinum in the first coating. The weight percent of platinum in the second coating may be greater than the weight percent of platinum in the first coating. The weight percent of platinum in the second coating may be approximately 2 and the weight percent of platinum in the first coating may be approximately 0.33.

A method of reducing the amount of hydrogen in fuel cell exhaust for steady state operation exhaust flow that contains a low concentration of hydrogen and for exhaust flow containing a short duration pulse of higher concentration hydrogen may comprise directing the flow of fuel cell exhaust through a first catalytic combustion zone in which the exhaust is exposed to a first hydrogen combustion catalyst, subsequently directing the flow of fuel cell exhaust through a second catalytic combustion zone in which the exhaust is exposed to a second hydrogen combustion catalyst, the second catalytic combustion zone may be configured and the second hydrogen combustion catalyst may be formulated to catalyze combustion of substantially all hydrogen in a flow of fuel cell vehicle exhaust during steady state operation, and the first catalytic combustion zone may be configured and the first hydrogen combustion catalyst may be formulated to catalyze combustion that at least substantially reduces the concentration of hydrogen in exhaust containing a pulse of higher concentration hydrogen. The concentration of hydrogen in a pulse of higher concentration hydrogen may be reduced by the first catalytic combustion zone to an amount that is substantially the same as the concentration of hydrogen in fuel cell exhaust during steady state operation. The first hydrogen combustion catalyst and the second hydrogen combustion catalyst may each comprise a coating of platinum and gamma alumina and the weight percent of platinum of the first hydrogen combustion catalyst may be less than the weight percent of platinum of the second hydrogen combustion catalyst. The first hydrogen combustion catalyst may comprise a coating of platinum and gamma alumina having a weight percent of platinum of approximately 0.33. The second hydrogen combustion catalyst may comprise a coating of platinum and gamma alumina having a weight percent of platinum of approximately 2.

I claim:

1. A catalytic hydrogen combustor comprising:
a monolith that forms a plurality of passageways that extend along a flow direction from an inlet to an outlet;
a first coating containing hydrogen combustion catalyst disposed on surfaces of the monolith that are adjacent to passageways in a first zone of the monolith between the inlet and a transition location between the inlet and the outlet;
a second coating containing hydrogen combustion catalyst disposed on surfaces of the monolith that are adjacent to passageways in a second zone of the monolith between the transition location and the outlet; and
the second coating formulated to catalyze hydrogen combustion at a greater rate than the first coating.

2. The catalytic hydrogen combustor of claim 1 wherein the first coating comprises ceramic and a hydrogen combustion catalyst and the second coating comprises ceramic and a hydrogen combustion catalyst.

3. The catalytic hydrogen combustor of claim 2 wherein the wherein the ceramic of the first coating is gamma alumina and the hydrogen combustion catalyst of the first coating is platinum.

4. The catalytic hydrogen combustor of claim 2 wherein the wherein the ceramic of the second coating is gamma alumina and the hydrogen combustion catalyst of the second coating is platinum.

5. The catalytic hydrogen combustor of claim 4 wherein the weight percent of platinum in the second coating is greater than the weight percent of platinum in the first coating.

6. The catalytic hydrogen combustor of claim 5 wherein the weight percent of platinum in the second coating is approximately 2 and the weight percent of platinum in the first coating is approximately 0.33.

7. The catalytic hydrogen combustor of claim 2 wherein the monolith comprises a honeycomb element and an outer shell that surrounds the honeycomb element from the inlet to the outlet.

8. The catalytic hydrogen combustor of claim 7 wherein the wherein the ceramic of the first coating is gamma alumina and the hydrogen combustion catalyst of the first coating is platinum and wherein the wherein the ceramic of the second coating is gamma alumina and the hydrogen combustion catalyst of the second coating is platinum.

9. The catalytic hydrogen combustor of claim 8 the weight percent of platinum in the second coating is greater than the weight percent of platinum in the first coating.

10. The catalytic hydrogen combustor of claim 9 wherein the weight percent of platinum in the second coating is approximately 2 and the weight percent of platinum in the first coating is approximately 0.33.

11. A method of reducing the amount of hydrogen in fuel cell exhaust for steady state operation exhaust flow that contains a low concentration of hydrogen and for exhaust flow containing a short duration pulse of higher concentration hydrogen comprising:
directing the flow of fuel cell exhaust through a first catalytic combustion zone in which the exhaust is exposed to a first hydrogen combustion catalyst;
subsequently directing the flow of fuel cell exhaust through a second catalytic combustion zone in which the exhaust is exposed to a second hydrogen combustion catalyst;
the second catalytic combustion zone configured and the second hydrogen combustion catalyst formulated to catalyze combustion of substantially all hydrogen in a flow of fuel cell vehicle exhaust during steady state operation; and
the first catalytic combustion zone configured and the first hydrogen combustion catalyst formulated to catalyze combustion that at least substantially reduces the concentration of hydrogen in exhaust containing a pulse of higher concentration hydrogen.

12. The method of reducing the amount of hydrogen in fuel cell exhaust of claim 11 wherein the concentration of hydrogen in a pulse of higher concentration hydrogen is reduced by the first catalytic combustion zone to an amount that is substantially the same as the concentration of hydrogen in fuel cell exhaust during steady state operation.

13. The method of reducing the amount of hydrogen in fuel cell exhaust of claim 11 wherein the first hydrogen combustion catalyst and the second hydrogen combustion catalyst each comprise a coating of platinum and gamma alumina and the weight percent of platinum of the first hydrogen combustion catalyst is less than the weight percent of platinum of the second hydrogen combustion catalyst.

14. The method of reducing the amount of hydrogen in fuel cell exhaust of claim 11 wherein the first hydrogen combustion catalyst comprises a coating of platinum and gamma alumina having a weight percent of platinum of approximately 0.33.

15. The method of reducing the amount of hydrogen in fuel cell exhaust of claim 11 wherein the second hydrogen combustion catalyst comprises a coating of platinum and gamma alumina having a weight percent of platinum of approximately 2.
